(19) United States
(12) Patent Application Publication
(10) Pub. No.: US 2007/0182260 A1
(43) Pub. Date: Aug. 9, 2007

(54) Motor rotor structure

(75) Inventors: Alex Horng, Kaohsiung (TW); Shih-Chang Huang, Kaohsiung (TW)

Correspondence Address: BIRCH STEWART KOLASCH & BIRCH, PO BOX 747, FALLS CHURCH, VA, 22040-0747, US

(73) Assignee: Sunonwealth Electric Machine Industry Co., Ltd.

(21) Appl. No.: 11/432,381

(22) Filed: May 12, 2006

(30) Foreign Application Priority Data
Feb. 6, 2006 (TW) 095103916

(51) Int. Cl. H02K 5/16

(52) U.S. Cl. 310/90

(57) ABSTRACT

A motor rotor structure includes a rotor having a center from which an axial seat protrudes for coupling with a shaft. The axial seat extends into an axial tube through which the shaft extends. A gap smaller than 1 mm exists between the axial seat and an inner circumferential wall of the axial tube. The axial seat includes a non-planar bottom face having a difference in height from a center of the shaft to a circumferential edge of the bottom face. The lubricating oil leaving an axial hole of a bearing in the axial tube impacts the bottom face and then flows back into the bearing along the bottom face. Outflow and loss of the lubricating oil are thus avoided.

### BACKGROUND OF THE INVENTION

1. Field of the Invention

The present invention relates to a motor rotor structure. More particularly, the present invention relates to a motor rotor structure capable of preventing outflow and loss of lubricating oil, thereby prolonging the life of the motor.

2. Description of Related Art

FIG. 1 illustrates a typical motor comprising a stator 10 and a rotor 20. The stator 10 includes an axial tube 11 in which a bearing 12 is mounted. The bearing 12 has a central axial hole 13 in the form of a through-hole. The rotor 20 is mounted around and covers the stator 10. A permanent magnet 21 is fixed to an inner circumferential wall of the rotor 20 and faces the stator 10. An axial seat 22 protrudes from a center of the rotor 20 for coupling with a shaft 23. The shaft 23 of the rotor 20 is extended through the axial hole 13 of the bearing 12 and turned under magnetic energizing.

However, the axial seat 22 of the rotor 20 is high above an upper end of the axial tube 11, leaving a relatively large gap between the axial seat 22 and the upper end of the axial tube 11 such that the lubricating oil in the axial tube 11 is liable to flow outward and thus lost via the gap.

The bearing 12 is generally used an oily bearing to keep smooth rotation of the shaft 23 of the rotor 20 in the axial hole 13 and lubricating oil is filled into the axial tube 11 to prevent severe friction between the shaft 23 and the bearing 12. The noise is reduced, as the lubricating oil reduces the friction resistance between the shaft 23 and the bearing 12. Hence, preservation of the lubricating oil and prevention of outflow and loss of the lubricating oil are important factors to the life and normal operation of the motor.

When the motor rotates at high speed, the lubricating oil originally contained in the bearing 12 spreads outward due to a rise in the temperature and moves upward along the shaft 23 and then finally exits via the axial hole 13 of the bearing 12. Since a large gap exists between the upper end of the axial tube 11 and the axial seat 22, the lubricating oil is liable to exit the motor via the gap, resulting in low rotational efficiency, generation of operational noise, and shortening of life of the motor.

It is therefore a need of better lubricating technique for preventing outflow and loss of the lubricating oil to improve the rotational efficiency and to prolong the life of the motor.

### SUMMARY OF THE INVENTION

A motor rotor structure in accordance with the present invention comprises a rotor having a center from which an axial seat protrudes for coupling with a shaft. An axial seat protrudes from a center of the rotor for coupling with a shaft. The axial seat extends into an axial tube through which the shaft extends. A gap smaller than 1 mm exists between the axial seat and an inner circumferential wall of the axial tube. The axial seat includes a non-planar bottom face having a difference in height from a center of the shaft to an outer circumferential edge of the bottom face.

The lubricating oil leaving an axial hole of a bearing in the axial tube could not escape from the axial tube. The lubricating oil leaving the axial hole impacts the bottom face and then flows back into the bearing along the bottom face. Outflow and loss of the lubricating oil are thus avoided.

In an embodiment, the bottom face of the axial seat is a conic face.

In another embodiment, the bottom face of the axial seat is a conic face with a central stepped portion.

In a further embodiment, the axial seat includes an annular groove defined by an arcuate wall.

In still another embodiment, the bottom face of the axial seat includes an annular groove defined by a rectangular wall.

Other objects, advantages and novel features of this invention will become more apparent from the following detailed description when taken in conjunction with the accompanying drawings.

### BRIEF DESCRIPTION OF THE DRAWINGS

FIG. 1 is a sectional view of a motor with a conventional rotor structure;

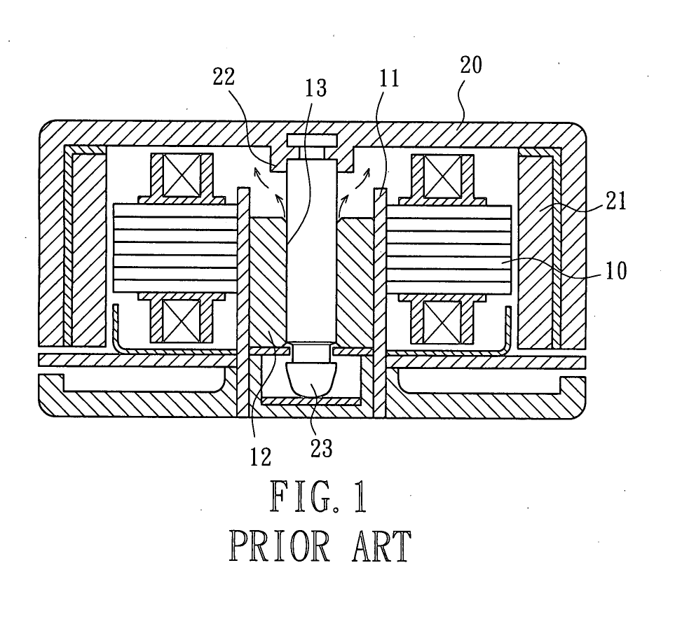

FIG. 2 is a sectional view of a motor with a first embodiment of a rotor structure in accordance with the present invention;

FIG. 3 is sectional view of a motor with a second embodiment of the rotor structure in accordance with the present invention;

FIG. 4 is sectional view of a motor with a third embodiment of the rotor structure in accordance with the present invention; and

FIG. 5 is sectional view of a motor with a fourth embodiment of the rotor structure in accordance with the present invention.

### DETAILED DESCRIPTION OF THE PREFERRED EMBODIMENTS

The present invention provides a motor rotor structure that preserve lubricating oil in the axial tube. Outflow and loss of the lubricating oil during rotation of the rotor are avoided, allowing smooth rotation of the rotor and reducing operational noise.

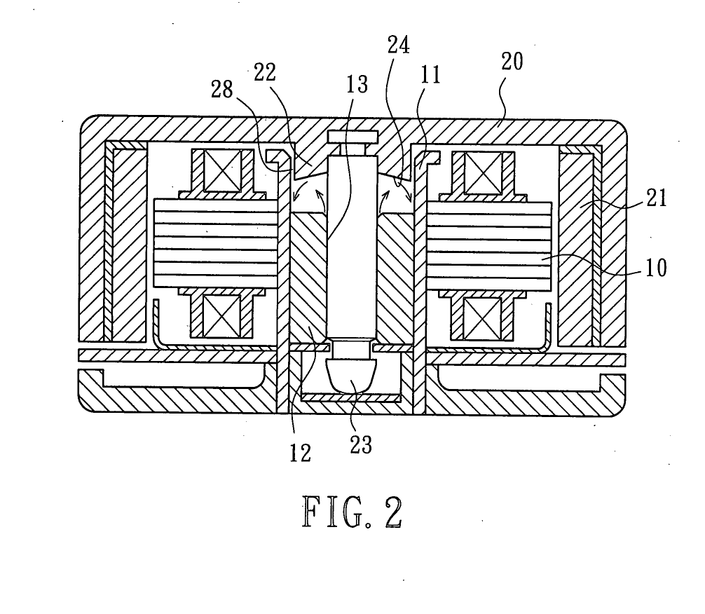

FIG. 2 illustrates a motor with a first embodiment of the present invention. The motor comprises a stator 10 and a rotor 20. The stator 10 includes an axial tube 11 in which a bearing 12 is received. The bearing 12 is preferably selected from an oily bearing and includes a central axial hole 13 in the form of a through-hole.

The rotor 20 is mounted around and covers the stator 10. A permanent magnet 21 is fixed to an inner circumferential wall of the rotor 20 and faces the stator 10. An axial seat 22 protrudes from a center of the rotor 20 for coupling with a shaft 23. The shaft 23 of the rotor 20 is rotatably extended through the axial hole 13 of the bearing 12.

The axial seat 22 extends into the axial tube 11 of the stator 10. Further, a gap 28 smaller than 1 mm exists between the axial seat 22 and an inner circumferential wall of the axial tube 11. Nevertheless, the axial seat 22 is not in contact with the inner circumferential wall of the axial tube 11.

By such an arrangement, when the lubricating oil leaves the axial hole 13 of the bearing 12, the small gap 28 between the axial seat 22 and the inner circumferential wall of the axial tube 11 preserves the lubricating oil in the axial tube 11 and thus avoids outflow of the lubricating oil.

A bottom face 24 of the axial seat 22 is preferably not planar. In the first embodiment shown in FIG. 2, the bottom face 24 is a conic face to provide a difference in height from a center of the shaft 23 to a circumferential edge of the bottom face 24. The lubricating oil leaving the axial hole 13 of the bearing 12 impacts the conic bottom face 24, flows on the bottom face 24 and then moves back into the bearing 12 under the pumping action resulting from operation of the motor. Outflow and loss of the lubricating oil are thus avoided.

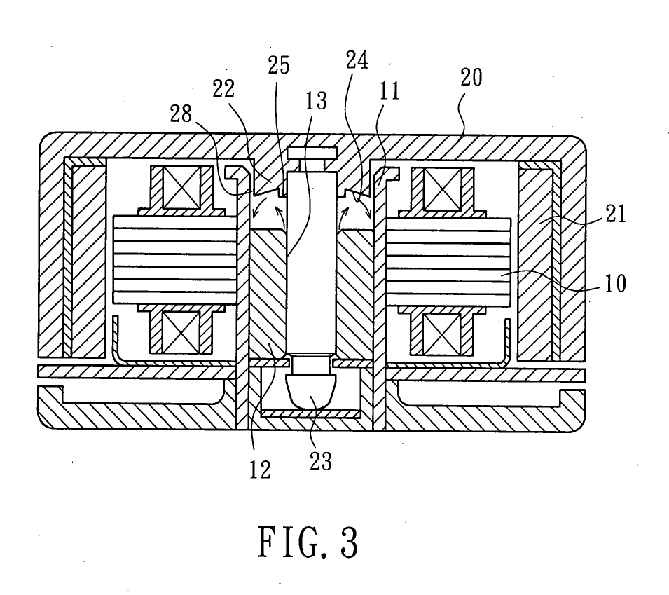

FIG. 3 shows a second embodiment of the invention, wherein the bottom face 24 is a conic face with a central stepped portion 25 to provide a difference in height from a center of the shaft 23 to a circumferential edge of the bottom face 24. Similarly, the lubricating oil leaving the axial hole 13 of the bearing 12 could not escape from the axial tube 11. The lubricating oil leaving the axial hole 13 impacts the conic bottom face 24 with a central stepped portion 25 and then flows back into the bearing 12 along the conic face. Outflow and loss of the lubricating oil are thus avoided.

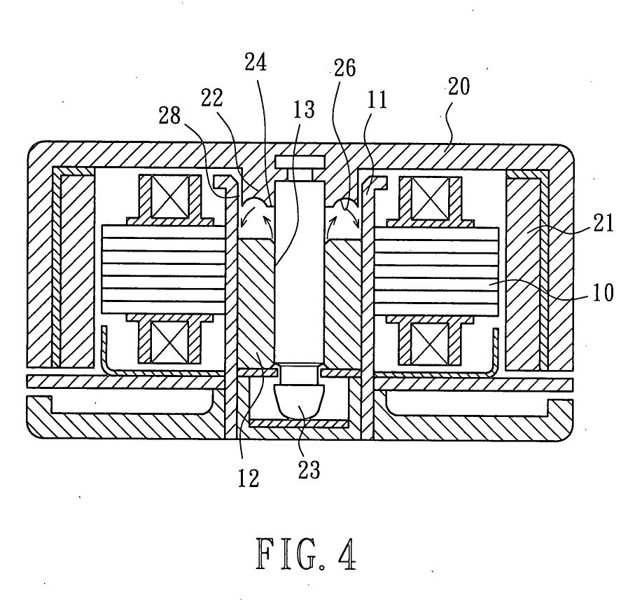

FIG. 4 shows a third embodiment of the invention, wherein the bottom face 24 includes an annular groove 26 defined by an arcuate wall to provide a difference in height from a center of the shaft 23 to a circumferential edge of the bottom face 24. Similarly, the lubricating oil leaving the axial hole 13 of the bearing 12 could not escape from the axial tube 11. The lubricating oil leaving the axial hole 13 impacts the bottom face 24 with an annular groove 26 and then flows back into the bearing 12 along the arcuate wall. Outflow and loss of the lubricating oil are thus avoided.

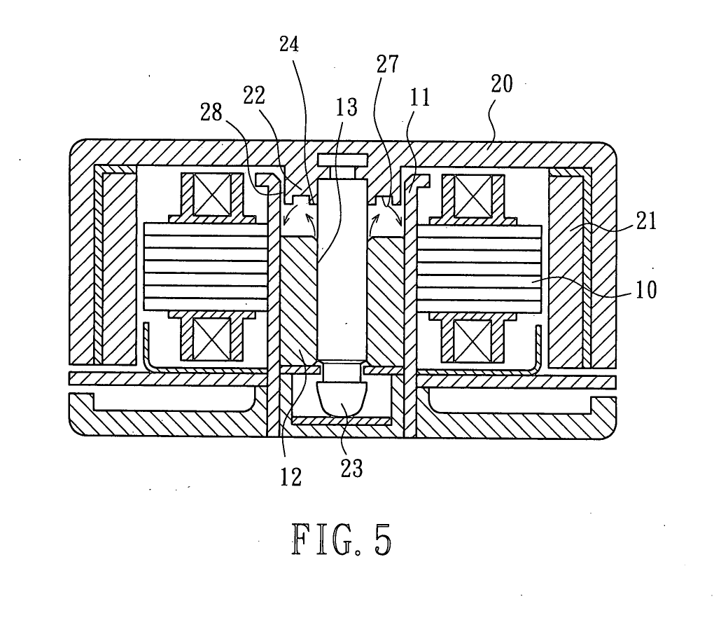

FIG. 5 shows a fourth embodiment of the invention, wherein the bottom face 24 includes an annular groove 27 defined by a rectangular wall to provide a difference in height from a center of the shaft 23 to a circumferential edge of the bottom face 24. Similarly, the lubricating oil leaving the axial hole 13 of the bearing 12 could not escape from the axial tube 11. The lubricating oil leaving the axial hole 13 impacts the conic bottom face 24 with an annular groove 27 and then flows back into the bearing 12 along the rectangular wall. Outflow and loss of the lubricating oil are thus avoided.

The lubricating oil is pushed back into the bearing 12 for circulation purposes under the pumping action resulting from operation of the motor. Thus, the lubricating oil can be preserved. Namely, outflow and loss of the lubricating oil during rotation of the motor are avoided, maintaining smooth rotation for the motor and reducing operational noise. Wear to the shaft 23 is avoided, the operational efficiency of the shaft 23 is improved, and the life of the motor is prolonged.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A motor rotor structure comprising a rotor, an axial seat protruding from a center of the rotor for coupling with a shaft, the axial seat extending into an axial tube through which the shaft extends, a gap smaller than 1 mm existing between the axial seat and an inner circumferential wall of the axial tube, the axial seat including a non-planar bottom face having a difference in height from a center of the shaft to an outer circumferential edge of the bottom face.

2. The motor rotor structure as claimed in claim 1 wherein the bottom face of the axial seat is a conic face.

3. The motor rotor structure as claimed in claim 1 wherein the bottom face of the axial seat is a conic face with a central stepped portion.

4. The motor rotor structure as claimed in claim 1 wherein the bottom face of the axial seat includes an annular groove defined by an arcuate wall.

5. The motor rotor structure as claimed in claim 1 wherein the bottom face of the axial seat includes an annular groove defined by a rectangular wall.
